(19) United States
(12) Patent Application Publication
(10) Pub. No.: US 2021/0235741 A1
(43) Pub. Date: Aug. 5, 2021

(54) Filled Roll Dough Product and Method of Producing

(71) Applicant: General Mills, Inc., Minneapolis, MN (US)

(72) Inventors: Cassee Malia Cain, Minneapolis, MN (US); Ryan D. Gifford, Golden Valley, MN (US); Lindsey Golinski, Minneapolis, MN (US); James N. Weinstein, Maple Grove, MN (US); Aaron P. Wlaschin, St. Paul, MN (US); Louis W. Woehrmann, Woodbury, MN (US)

(21) Appl. No.: 17/160,904

(22) Filed: Jan. 28, 2021

Related U.S. Application Data
(60) Provisional application No. 62/968,280, filed on Jan. 31, 2020.

(51) Int. Cl. A23P 30/20; A21D 6/00; A21D 2/18; A21D 8/02; A21D 13/31

(52) U.S. Cl. CPC A23P 30/20; A21D 6/003; A21D 13/31; A21D 8/02; A21D 2/188

(57) ABSTRACT

Filled roll dough products, such as pizza rolls, are made with an outer dough shell with an internal filling material. Versus a conventional pizza roll, pizza rolls in accordance with the invention employs a filling material having a lower viscosity upon heating due to the removal of a majority of a viscosity altering additive (e.g., methyl cellulose) used in a conventional filling and an outer dough shell formed with spaced internal ridges which increase the structural integrity of the outer shell while not at all changing the external appearance. While removal of the viscosity altering additive from the filling material increases a blow-out rate for the product, the inclusion of the ridges decreases the blow-out rate to the extent that either a reduction or no significant change in product blow-rates is produced.

### CROSS-REFERENCE TO RELATED APPLICATIONS

This application claims the benefit of U.S. Provisional Patent Application Ser. No. 62/968,280, which was filed on Jan. 31, 2020 and titled “Filled Roll Dough Product and Method of Producing”. The entire content of this application is incorporated by reference.

### BACKGROUND OF THE INVENTION

The present invention pertains to a dough product with a filling and, more particularly, to producing internally filled dough products, such as pizza rolls, having enhanced structural integrity upon cooking.

A variety of filled dough products including an outer dough crust and an inner filling of another material are known in the art. Pizza rolls represent a popular option. When producing pizza rolls on a commercial scale, a co-extrusion process is typically employed wherein an elongated outer shell or crust of dough is extruded to surround a filling, which can include various components such as sauces, cheeses, meats and the like, and then ends of the outer shell are pinched and severed to establish individual pizza rolls. Most often, the pizza rolls are initially pre-cooked and frozen, then sold to consumers for later reheating of the pizza rolls for consumption.

Regardless of whether the pizza rolls are pre-cooked or immediately frozen upon production, the fact of the matter is the pizza rolls need to be cooked. Although heating can be performed using microwave heating technology, it is generally recommended to heat the pizza rolls in a conventional oven where the products are heated through radiant and, perhaps, convection heat sources from outside the product to inside the product in order to obtain a toasted and crispy outer crust. Unfortunately, it is not uncommon for a significant percentage of such filled roll dough products of this type to burst or blow-out during cooking, particularly during consumer baking. In connection with pizza rolls in particular, it is known to include one or more additives in the filling material which aid in reducing blow-outs from occurring. For instance, it is common to employ methyl cellulose in this food art, with the methyl cellulose constituting a viscosity altering additive having a property that causes the viscosity of the filling material to increase when the temperature of the filling material is raised.

In accordance with the present invention, it is desired to substantially reduce the amount of viscosity altering additive included in the filling material, either without affecting or, more preferably, further reducing the frequency of undesirable blow-outs during cooking.

### SUMMARY OF THE INVENTION

A filled roll dough product in accordance with the present invention is produced having a filling material with reduced viscosity when heated and a structurally reinforced outer shell or crust as compared to a conventional filled roll dough product. More specifically, the outer shell of the product is formed with spaced internal ridges which increase the structural integrity of the outer shell while not at all changing the external appearance or minimum crust dimension. Most preferably, the dough for the outer shell and the inner filling material are co-extruded, with multiple, longitudinally extending ridges being formed internally, such as by machining a series of spaced divets or grooves into the die nozzle for the flow of added dough as part of the outer shell. While it has been found that the removal of the viscosity altering additive from the filling material increases a blow-out rate for the product, the inclusion of the ridges substantially decreases the blow-out rate for the product, with the magnitude of the rate decrease essentially countering the magnitude of the increase such that no significant change in product blow-rates is produced.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1 is a schematic view of a production assembly used to produce filled roll products in accordance with the present invention;

FIG. 2 shows a pizza roll product made in accordance with the invention, with the pizza roll being opened in half to show the filling material inside of the pizza roll; and

FIG. 3 shows a pizza roll opened like in FIG. 2 but without the filling material.

### DETAILED DESCRIPTION OF THE INVENTION

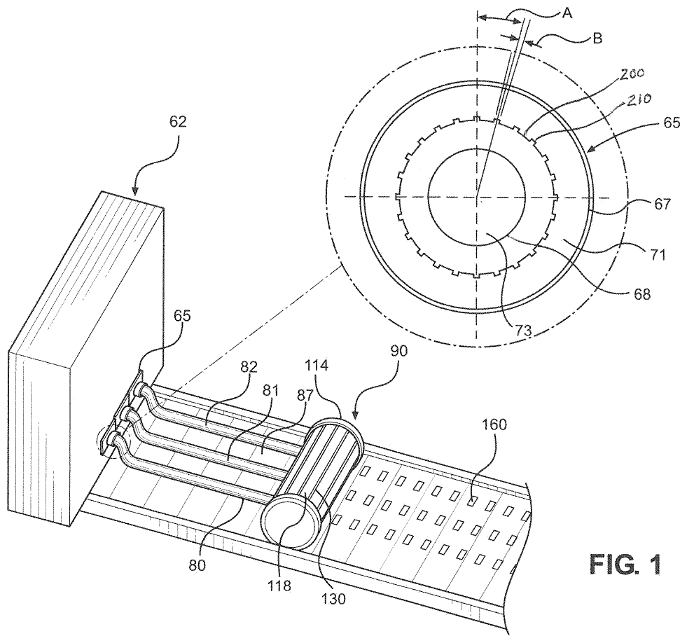

As discussed above, the present invention is directed to the making of filled roll products, each having an outer dough shell and an inner filling material. Although these products can be made in various ways, reference will initially be made to FIG. 1 in describing an exemplary manufacturing assembly line arrangement employed to make pizza rolls, with this exemplary arrangement being presented for purposes of fully understanding the invention. As shown, the arrangement of FIG. 1 employs a multi-row extruder 62 having a plurality of laterally spaced heads, one of which is indicated at 65. As shown in the enlarged view, each head 65 includes an outer channel defining member 67 and a concentric, inner channel defining member 68 establishing an outer die port 71 and a central die port 73. Flowing through outer die port 71 is an outer dough material, while a filling material simultaneously flows through central die port 73. At this point, it should be noted that the radial spacing between outer die ports 71 and central die port 73 could be avoided by having the inner radial wall for the outer die port also define the central die port, i.e., basically remove inner channel defining member 68. In any case, extruder 62 forms a plurality of elongated, laterally spaced rows, exemplified by rows, of food product which are deposited, in the form of continuous ropes 80-82, onto a common conveyor 87.

Downstream of extruder 62 is provided a combination crimping and cutting assembly which is generally indicated at 90 extending across conveyor 87. In the exemplary embodiment disclosed, combination crimping and cutting assembly 90 includes a roller 114 having an outer surface 118 from which project a plurality of laterally extending and circumferentially spaced crimping and cutting members, one of which is indicated at 130. As ropes 80-82 are directed beneath crimping and cutting assembly 90, individual filled roll dough products 160 are continuously produced through a pinching and severing operation, with each roll product 160 including an outer dough shell or casing which encapsulates the inner filling material.

At this point, it should be noted that the above-described production stages could be performed manually but, more preferably, are part of a mass production process. Certainly, if mass produced, even more than three product lines could be established using conveyor 87. Actually, this general type of arrangement is known in the art for use in producing pizza rolls including an outer shell or crust of dough extruded to surround an inner filling, which can include various components such as sauces, cheeses, meats and the like. As indicated above, most often, the pizza rolls are initially pre-cooked and frozen, then sold to consumers for later reheating of the pizza rolls for consumption. Therefore, for this portion of the description is basically presented for the sake of completion. Instead, in accordance with one aspect of the present invention, the filling material is modified while, in accordance with another aspect of the invention, the configuration of the outer dough shell is changed to avoid any increase in blow-outs of the roll products 160 upon cooking, particularly based on the modified filling.

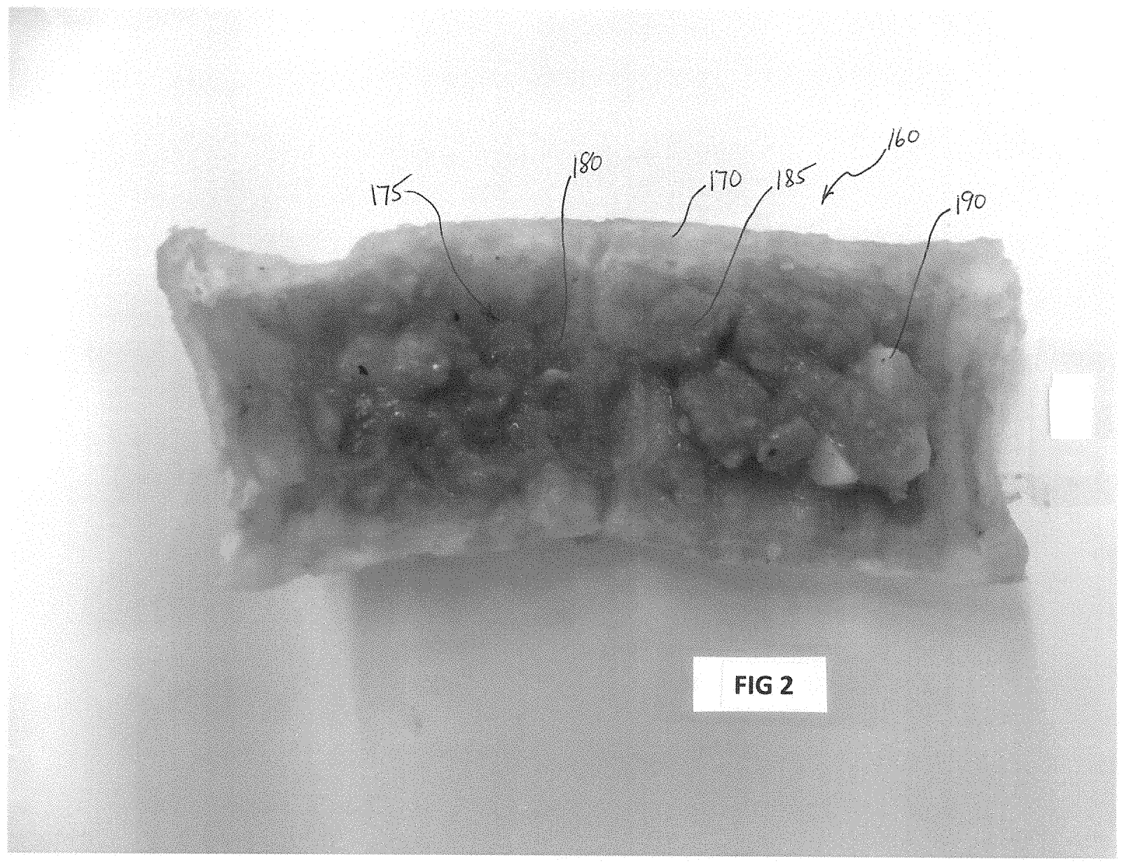

Before further discussing aspects of the invention reflected in FIG. 1, FIG. 2 is referenced to discuss changes made in connection with the filling material. In this figure, a pizza roll 160 has been cooked, sliced in half and outer dough shell 170 opened to reveal filling material generally indicated at 175. As shown, filling material 175 includes sauce 180, chunks of tomato (one of which is indicated at 185), pieces of meat (one of which is indicated at 190), spices and the like. Most importantly, compared to conventional pizza roll fillings available on the market today, filling material 175 has a significant reduction in the amount of methyl cellulose employed in making filling material 175. More specifically, in the most preferred embodiment, the ingredients of the conventional or control filling versus a modified filling in accordance with the invention are set forth in Table 1 below:

TABLE 1

| | Control | Modified Filling |
|---|---|---|
| Ingredients | (%) | (%) |
| STARCH MODIFIED WAXY | 1.915 | 2.104 |
| MAIZE PRE | | |
| SALT MEDIUM FINE (NO | 0.779 | 0.782 |
| FILLER AD | | |
| ONION WHITE MINCED | 0.468 | 0.470 |
| DEHYDRATED | | |
| GRANULATED SUGAR | 0.359 | 0.360 |
| OREGANO GROUND MEXICAN | 0.192 | 0.193 |
| METHYLCELLULOSE | 0.211 | 0.057 |
| CAYENNE PEPPER RED GROUND | 0.055 | 0.055 |
| BASIL COARSE GROUND | 0.036 | 0.036 |
| GARLIC EXTRACTIVES ON | 0.012 | 0.012 |
| DEXTROSE | | |
| ANISE FLAVOR-10X NATURAL | 0.011 | 0.011 |
| STARCH WAXY MAIZE MODIFD | 0.000 | 0.897 |
| UNGLT | | |
| Water | 40.020 | 39.082 |
| Tomato Paste 31% Solids | 15.926 | 15.926 |
| Snacks Cheese | 17.000 | 17.000 |
| Pepperoni | 23.000 | 23.000 |
| SOYBEAN OIL #31 HIGH OLEIC W/ | 0.015583 | 0.0154752 |
| Total | 100.0000 | 100.0000 |

Based on the above, it should be clear that a majority (greater than 50%) of the methyl cellulose has been removed, more preferably, greater than 65% and, most preferably closer to 75%. In the embodiment shown, 73% of the methyl cellulose used in a conventional pizza roll filling has actually been removed, without the addition of any substitute viscosity altering additive, i.e., additive to increase the viscosity. Although other additives could be employed such that methyl cellulose is presented here as exemplary, methyl cellulose is commonly used in the art as it has properties that cause the filling viscosity to increase when the filling temperature in raised. The increased viscosity correlates to lower blow-out rates. Still, it is considered that, by removing this methyl cellulose, a more authentic sauce is employed, resulting in improved taste and mouth-feel of the overall food product. However, while it is desired to remove at least a majority of the methyl cellulose, this desired action could not reasonably be implemented due to the significant increase in the rate of blow-outs during cooking of the pizza rolls with this single change. By way of example, an average blow-out rate for a non-modified, conventionally known pizza roll (control group) baked for 15 minutes in various types of ovens at 425° F. were found to be around 40% (average in tests conducted were 39.3%). However, tests conducted on pizza rolls with the single change of a filling material employing only 27% of the methyl cellulose used in the control group, resulted in an average blow-out rate of 53.3%. Noting this blow-out rate increase, the reduction in methyl cellulose could not be justified.

With the above in mind, reference will now be made again to FIG. 1 in detailing another aspect of the invention. As specifically shown in the enlarged portion of FIG. 1, the inner radius portion of the outer die port 71 through which flows the dough material for outer dough shell 170 includes a series of teeth portions, one of which is labeled 200, spaced by divider portions, one of which is labeled 210. In the embodiment shown, twenty-four (24) evenly spaced teeth portions 200 are established, with an angular spacing A of 15 degrees and a divider dimension of 2B. For the sake of completeness, one embodiment employs a 2B (width) dimension of 0.046 inches and a divider depth of 0.028 inches. However, these numbers can certainly be varied, e.g., establishing 6 or 24 teeth portions. Preferably, teeth portions 200 are uniformly, circumferentially spaced, although this is not mandatory in accordance with the overall invention. In addition, it should be recognized that teeth portions 200 and divider portions 210 can be formed in different ways, such as by adding elongated divets or grooves in the die. Certainly, the shape of the dividers and teeth can also vary, e.g., employing radiused configurations.

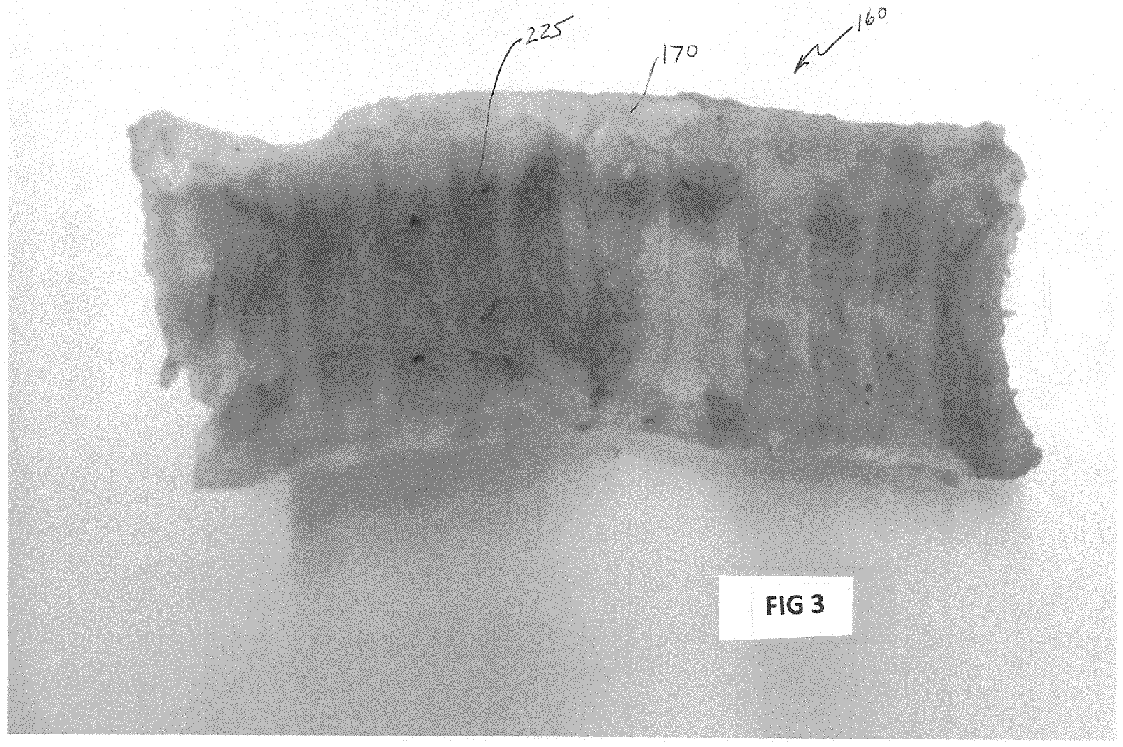

With this construction for die port 71, an inside of outer dough shell 170 of roll dough product 160 is formed with a plurality of spaced internal ridges 225 as best shown in FIG. 3. That is, ropes 80-82 are formed with longitudinally extending internal projections (not shown) which, once roll dough product 160 is fully formed and cooked, results in ridges 225. The inclusion of ridges 225 does not affect the outer surface or appearance of pizza roll 160 and does not result in any change in the total outer dimension, but does result in a higher overall dough percentage in the finished product. However, the inclusion of ridges 225 has been found to structurally reinforce the outer shell or crust 170 and significantly reduce the rate of blow-outs. In fact, with the combination of reduced methyl cellulose and the inclusion of ridges 225, pizza rolls 160 have been found to have blow-out rates not significantly different from conventional (i.e., control group as discussed above) pizza rolls. More specifically, tests have shown blow-out rates in pizza rolls 160 constructed in accordance with the invention to be essentially identical to (actually below) the control group (average in tests conducted were 38.7%).

With the above in mind, it should be readily apparent that the present invention provides for dough roll products advantageously including a filling material having a distinct viscosity upon heating without any significant blow-out increase rate. This change (lowering) in viscosity also advantageously results in a significant reduction in required pump pressure, with test results showing a mean control or conventional filling pump pressure of 64.67 psi versus a mean modified filling pump pressure of 59.55 psi (noting higher viscosities require higher pump pressures). At this same time, another benefit is the reduced cost associated with producing the pizza rolls due to the use of lower amounts of methyl cellulose. Of course, although the invention has been mainly disclosed with reference to making pizza rolls employing methyl cellulose, the invention is also applicable in making other filled roll dough products wherein altering the viscosity of the filling material could be beneficial but would result in reduced integrity of an outer shell of the product upon cooking.

1. A method of producing a filled roll dough product by dispensing a filling material within an outer dough shell having a plurality of spaced internal ridges.

2. The method of claim 1, further comprising coextruding the outer dough shell and the filling material, with the outer dough shell being extruded with elongated, radially extending projections corresponding to the plurality of spaced internal ridges.

3. The method of claim 2, wherein the outer dough shell and the filling material are coextruded as a rope with internal projections resulting in the plurality of spaced internal ridges, said method further comprising cutting and crimping a section of the rope to establish the filled roll dough product.

4. The method of claim 1, wherein the filling material has a decreased viscosity upon heating the filling material as compared to a conventional filling material.

5. The method of claim 4, wherein the filling material has a reduced amount of a viscosity altering additive as compared to a conventional filling material, without the addition of any substitute viscosity altering additive.

6. The method of claim 5, wherein the reduced amount equates a reduction greater than a majority of the viscosity altering additive used in a conventional filling material.

7. The method of claim 6, wherein the filling material lacks close to 75% of the viscosity altering additive used in a conventional filling material.

8. The method of claim 5, wherein the viscosity altering additive is methyl cellulose.

9. The method of claim 1, wherein the filled roll dough product is a pizza roll.

10. The method of claim 9, wherein the filled roll dough product includes six or more of the plurality of spaced ridges.

11. The method of claim 10, wherein the filled roll dough product includes twenty-four of the plurality of spaced ridges.

12. A filled roll dough product comprising:
an inner filling material;
an outer dough shell formed with a plurality of spaced internal ridges; and
a plurality of exposed filling regions spaced between respective ones of the plurality of spaced internal ridges.

13. The filled roll dough product of claim 12, wherein the filling material has a decreased viscosity when heated as compared to a conventional filling material.

14. The filled roll dough product of claim 13, wherein the filling material has a reduced amount of a viscosity altering additive as compared to a conventional filling material, without the addition of any substitute viscosity altering additive.

15. The filled roll dough product of claim 14, wherein the reduced amount equates a reduction greater than a majority of the viscosity altering additive used in a conventional filling material.

16. The filled roll dough product of claim 15, wherein the filling material lacks close to 75% of the viscosity altering additive used in a conventional filling material.

17. The filled roll dough product of claim 14, wherein the viscosity altering additive is methyl cellulose.

18. The filled roll dough product of claim 12, wherein the filled roll dough product is a pizza roll.

19. The filled roll dough product of claim 12, wherein the filled roll dough product includes six or more of the plurality of spaced ridges.

20. The filled roll dough product of claim 19, wherein the filled roll dough product includes twenty-four of the plurality of spaced ridges.

21. An apparatus for producing filled roll dough products comprising:
an outer dough extruder die including a plurality of inner radially extending protrusions spaced by divider portions for forming an outer dough shell having a plurality of spaced internal ridges; and
an inner filling material die configured to extrude an inner filling material within the outer dough shell.

22. The apparatus of claim 21, wherein the plurality of inner radially extending protrusions are circumferentially, evenly spaced and range in number between 6 and 24.
